(19) United States
(12) Patent Application Publication
(10) Pub. No.: US 2013/0138556 A1
(43) Pub. Date: May 30, 2013

(54) METHOD OF WARRANTING THIRD PARTY PAYMENT FOR A RENTER OR PURCHASER

(71) Applicant: Elbie D. Wallace, JR., Matthews, NC (US)

(72) Inventor: Elbie D. Wallace, JR., Matthews, NC (US)

(21) Appl. No.: 13/549,449

(22) Filed: Jul. 14, 2012

Related U.S. Application Data
(63) Continuation-in-part of application No. 09/852,867, filed on May 10, 2001, now abandoned.

(51) Int. Cl. G06Q 30/06; G06Q 50/16

(52) U.S. Cl. CPC G06Q 30/0645; G06Q 40/025
USPC 705/38

(57) ABSTRACT

A method wherein a third party, a guarantor, runs a qualifying check on a potential renter. If a potential renter qualifies against the guarantor's criteria which are less demanding than the conventional criteria used by typical apartment complex management, the guarantor warrants the landlord (apartment complex management) against default by the renter. With this degree of assurance, the landlord is willing to lease the space.

### CROSS-REFERENCE TO RELATED APPLICATION

The present application is a U.S. continuation-in-part patent application of, and claims priority under 35 U.S.C. §120 to, U.S. nonprovisional patent application Ser. No. 09/852,867, filed May 10, 2001, which nonprovisional patent application published as U.S. patent application publication no. 2002/0169641, which patent application and publication are incorporated by reference herein.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE PRESENT INVENTION

1. Field of the Present Invention

The present invention relates generally to a method of enabling access to rental housing by potential renters who do not qualify by conventional leasing standards, and more particularly, to the establishment of a warranty against rent default by a renter so that the landlord grants a lease to the renter.

2. Background

Many individuals have marginal creditworthiness. For example, a history of slow payment of debts or a bankruptcy can produce a negative credit report. A young person may have marginal creditworthiness simply by lacking a credit history. Presently, such individuals are rejected by landlords when they apply to rent housing based on a creditworthiness report from one of the retail credit reporting companies. When this happens, the rejected individual is forced to reside in publicly subsidized housing which may be inferior to rental housing being sought, by requiring, for example, a substantially longer commute to the potential landlord's place of employment or living in a less desirable neighborhood.

A typical rental process sequence is as follows. a potential renter applies to an apartment complex to rent available space. The management of the apartment complex runs a credit check and a background check consisting of a search for disqualifying criminal history. If the potential renter fails to qualify, the rental does not take place.

Often the rejection is based on marginal creditworthiness due to poor credit history or no credit history. Neither the potential landlord nor the management of the apartment complex has any recourse when this occurs. What is needed is a mechanism whereby potential renters who do not qualify on conventional grounds can have a chance to rent a desired residential space.

### SUMMARY OF THE PRESENT INVENTION

According to various aspects of the present invention, a method is provided wherein a third party, a guarantor, runs a qualifying check on a potential renter. If the potential renter qualifies against the guarantor's criteria, which are less demanding than the conventional criteria used by typical apartment complex management, the guarantor warrants the landlord (apartment complex management) against default by the renter. With this degree of assurance, the landlord is willing to enter into the lease. Thus, a means is provided wherein individuals who are applying for a lease, but who do not qualify against conventional creditworthiness criteria, to be qualified under less stringent criteria with a third party, whereupon the third party warrants the landlord against default by the potential renter and the previously unobtainable lease agreement may be consummated.

According to the present invention, the method of a guarantor warrantying a landlord against rent default by the renter includes verifying the potential renter against lease warranty criteria by the lease guarantor. Qualifying the renter against a lease warranty includes the steps of: 1) qualifying the renter against the background check, 2) qualifying the renter against a modified credit check, and 3) qualifying the renter against an employment check. Where a renter qualifies against these checks, the guarantor provides a warranty to the landlord against default by the renter in exchange for the landlord granting a lease to the renter.

According to another aspect of the present invention, the background check includes investigating the renter's background for a felony and denying the warranty if the renter has a felony conviction. Additionally, the modified credit check includes reviewing the renter's credit for past due utility bills and denying the warranty if the renter has a past due utility bill.

According to a further aspect of the present invention, the employment check includes the steps of: 1) verifying that the renter is currently employed, 2) verifying that the renter has been continuously employed for a specified number of months, such as eight, 3) verifying that the renter's annual income is at least a certain minimum amount, such as Fifteen Thousand Dollars ($15,000), and 4) verifying that the renter has attained a specified age, such as, at least twenty one years.

According to a still further aspect of the present invention, the warranty covers the payment of a remaining portion of the lease if there is default by the renter. Additionally, the method includes the step of paying the guarantor a fee for the warranty.

According to another aspect of the present invention, the renter can remotely apply to qualify for the lease warranty by completing a guarantor's application on an Internet website.

According to a further aspect of the present invention, the method can include the step of providing a data base of landlords who would be willing to accept the warranty by the guarantor. Additionally, the method can include the step of notifying the landlords listed on the data base via the Internet of a renter who is qualified by the guarantor.

Broadly defined, the present invention according to one aspect is a method of warranting receipt of payment by a landlord for a renter, thereby enabling housing for a greater number of people, including: generating, by a guarantor, a list of landlords seeking to enter into a warranted lease agreement, the list including at least one residential space offered by each respective landlord; utilizing, by a potential renter, a computer program stored on a computer readable media and implemented by a computer, to select a desired residential space; utilizing a computer program stored on a computer readable media implemented by a computer, qualifying the potential renter against a lease warranty criteria including qualifying the renter against a background check, qualifying the renter against a credit check, and qualifying the renter against an employment check; utilizing a computer program stored on a computer readable media implemented by a computer, calculating the cost of a warranted lease of the desired residential space for the potential renter wherein the cost is graduated on the basis of the qualifying step and on other predetermined criteria; warranting receipt of payment, by the landlord of the desired residential space with a warranty, by the lease guarantor, against default by the renter, whereby the landlord offers the warranted lease to the renter; entering into the warranted lease upon acceptance by the landlord and the renter.

In a feature of this method, the method further includes a step of making payment, upon a default by the renter (default being defined as a failure by the renter to make his lease payment to the landlord), making payment, by the guarantor, of the lease payment to the landlord.

In another feature of this method, an ejectment conviction is required before the renter is deemed to be in default. In a further feature, the method further includes a step of the potential renter completing a guarantor's application on an internet website to qualify the renter against the lease warranty criteria.

In another feature of this method, the method further includes a step of providing the list of landlords in the form of a database. In a further feature, the method also includes a step of notifying the landlords in the database, via the Internet, of qualification by the guarantor.

Broadly defined, the present invention according to another aspect is a method of enabling housing for a greater number of people, where a guarantor warrants against default, including: qualifying a potential renter a chance to rent a desired residential space against a lease warranty criteria including qualifying the renter against a background check, qualifying the renter against a credit check, and qualifying the renter against an employment check; utilizing a computer program stored on a computer readable media implemented by a computer, calculating the cost of a warranted lease of the space for the potential renter wherein the cost is graduated on the basis of the potential renter's annual income, where the renter is qualified, regardless of: judgment for non-payment of rent, bankruptcy, automobile repossession, unpaid medical bills, unpaid student loans and lack of credit; generating a list of landlords seeking to enter into a warranted lease agreement, said potential renter utilizing the list to select the desired residential space; offering a warranted lease to the renter; selling the lease warranty to the landlord leasing the space when the renter enters into the warranted lease; and warranting the landlord against default by the renter.

Broadly defined, the present invention according to another aspect is a method of enabling housing for a greater number of people, where a guarantor warrants against default, including: qualifying a renter a chance to rent a desired residential space against a lease warranty criteria including qualifying the renter against a background check, qualifying the renter against a credit check, and qualifying the renter against an employment check; utilizing a computer program stored on a computer readable media implemented by a computer, calculating the cost of a warranted lease of the space for the potential renter wherein the cost is graduated on the basis of the potential renter's annual income, where the renter is qualified, regardless of: judgment for non-payment of rent, bankruptcy, automobile repossession, unpaid medical bills, unpaid student loans and lack of credit; generating a list of landlords seeking to enter into a warranted lease, said potential renter utilizing the list to select the desired residential space; offering the lease warranty to the renter; and selling the lease warranty to the renter when the renter enters into a lease with a landlord; wherein the warranty warrants the landlord against default by the renter.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Further features, embodiments, and advantages of the present invention will become apparent from the following detailed description with reference to the drawings, wherein:

FIG. 1 is diagrammatic flow chart of the invented method; and

FIG. 2 is a diagrammatic flow chart of FIG. 1 listing additional steps.

### DETAILED DESCRIPTION

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. As should be understood, any embodiment may incorporate only one or a plurality of the above-disclosed aspects of the invention and may further incorporate only one or a plurality of the above-disclosed features. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers,” “a picnic basket having crackers without cheese,” and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, in which like numerals represent like components throughout the several views, one or more preferred embodiments of the present invention are next described. The following description of one or more preferred embodiments is merely exemplary in nature and is in no way intended to limit the invention, its implementations, or uses.

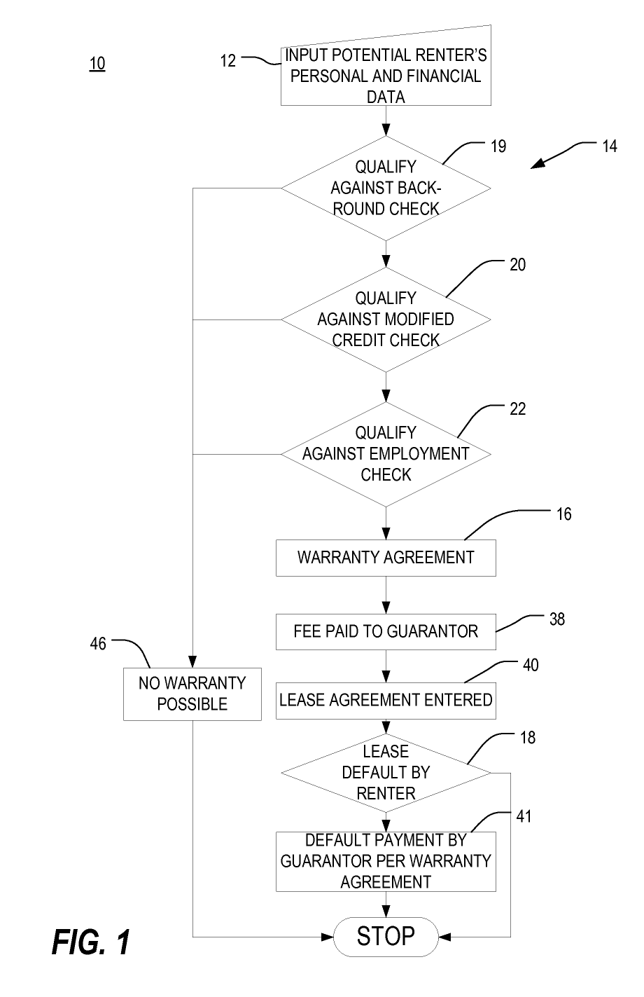

The present invention provides a method for enabling access to leased housing to a potential renter who does not qualify against conventional leasing standards. As shown in FIG. 1, the invented method 10 includes inputting and processing personal and financial data 12 to qualifying the potential renter against a lease warranty criteria 14. If the renter qualifies, then a lease guarantor warranties 16 the lease against default 18 by the renter. Prior art methods utilize a background check and a credit check to determine if a lease will be granted to the renter. The background check includes review of the renter's criminal record. If a significant criminal record is found, then no lease is possible. A potential renter that meets the background check is further processed by a retail credit check generally via telecommunication means. The credit check includes review for judgment for non-payment, bankruptcy, automobile repossession, medical bills, utilities, student loans, and no credit. Aside from student loans and no credit, default on any of the retail credit check categories results in a “no lease possible” outcome.

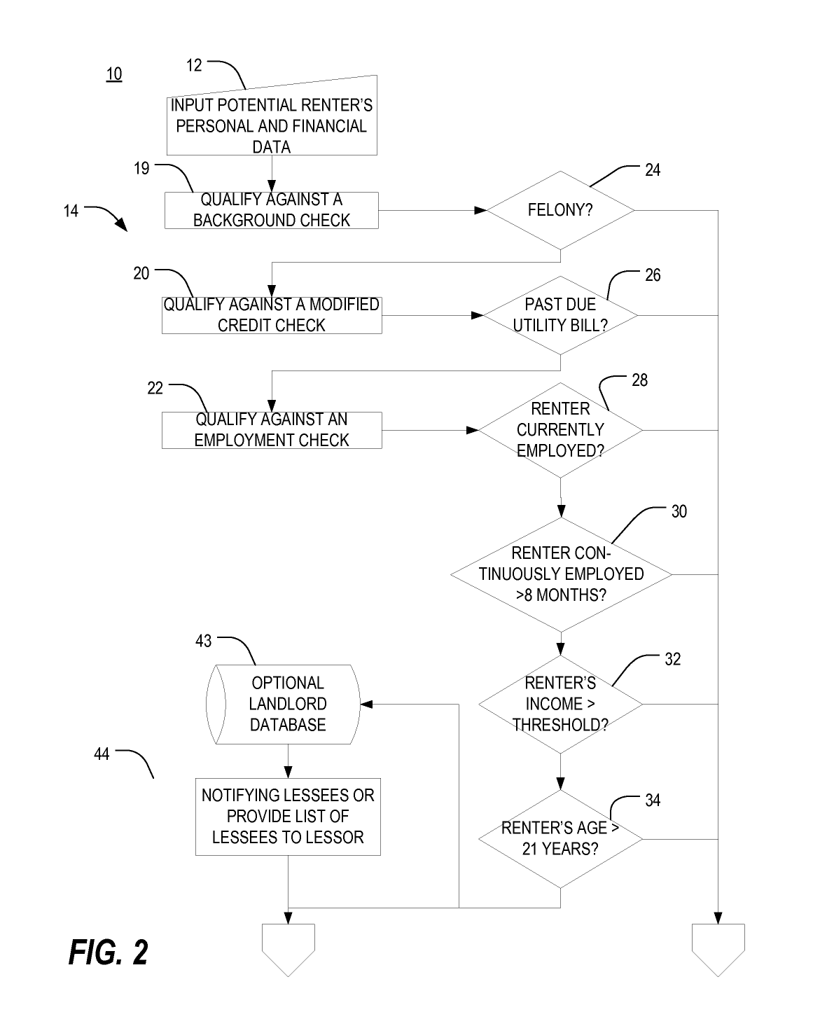

As illustrated in FIG. 2, a renter denied a lease under prior art methods may still be able to obtain a lease by using the method 10 of the present invention. Under the present invention, the lease guarantor qualifies the potential renter against the lease warranty criteria 14. If the renter is approved, the guarantor warranties 16 the landlord against default 18 by the renter. The lease warranty criteria 14 includes: 1) qualifying the renter against the background check 19; 2) qualifying the renter against a modified credit check 20; and 3) qualifying the renter against an employment check 22. The background check 19 is similar to prior art background checks in that the renter will not qualify if they had been convicted of a felony 24.

The modified credit check 20 can include review of the same information as the prior art credit check. However, automatic rejection from qualifying occurs only when the renter is in default of paying a utility bill 26. Consequently, the renter can be approved despite having a judgment against him for non-payment, bankruptcy, automobile repossession, medical bills or student loans, or no credit.

The employment check 22 includes the steps of: 1) verifying that the renter is currently employed 28, 2) verifying that the renter has been continuously employed for the previous specified number of (eight) months 30, 3) verifying that the renter's annual income is at least a certain amount (Fifteen Thousand Dollars ($15,000)) 32, and 4) verifying that the renter's age is at least twenty-one years 34. Additionally, the employment check 22 can require that the renter's annual income is at least fifty times the amount of monthly rent. An alternative method adjusts the required annual income 32 by any method such as, for example, a fixed percent, the cost of living index as of Jan. 1, 2001, a fixed amount, etc.

Where the renter qualifies against the lease warranty criteria 14, the guarantor enters a warranty agreement 16 with the landlord against default 18 of rent payment by the renter. In consideration of warranting 16 the lease, the guarantor receives a fee 38 and the landlord enters a lease agreement 40 with the renter. The warranty 16 provides that upon default 18 of rent payment by the renter, the guarantor will provide default payment 41 for at least a portion of the remaining term of the lease. The default payment 41 can be limited such as, for example, to cover only two months of the remaining months of the lease. Additionally, the warranty 16 can be limited in duration. For example, the warranty 16 can extend for only a portion of the lease agreement 40 such as covering only the first half of the lease. Typically, the obligation under the warranty 16 will not become effective until there is verification 42 that the renter is in default 18. Methods for verifying 42 that the renter is in default 18 include: 1) an ejectment conviction, and 2) verification that the renter has abandoned the leasehold by physical inspection by or on behalf of the guarantor.

The fee 38 to the guarantor is typically paid by the renter. The fee 38 can be determined by any of a variety of methods. For example, the fee 38 can be based according to a percent of the annual rental rate, or a percent of the renter's annual income, or graduated according to a range of the annual rental price or a range of the renter's annual income. Additionally, the fee 38 can be adjusted upward or downward depending on the number of misdemeanor convictions and/or the extent of defaults as indicated by a standard background check. Typically, bankruptcy will result in the fee being adjusted upward by a multiplier such as, for example, by a factor from 1.1 to 1.5.

An Internet website can also be provided so that the renter can remotely input personal and financial data 12 to apply to qualify for the lease warranty 16 by completing and submitting an online application. The fields of the application are to be completed with information sufficient for the background check 18, modified credit check 20 and employment check 22 to be conducted. Examples of appropriate fields include the potential renter's name, address, Social Security Number, name of employers over the previous eight months, telephone numbers of such employers, date of birth, number of consecutive months employed, etc.

A data base 43 can be provided of landlords who would grant a lease to a renter based on the warranty by the guarantor. The landlords can be notified 44 via the Internet, or by any other method, of a renter who is qualified by the guarantor. Also, a list of landlords can be provided to the renter.

The steps of the method 10 can be performed by a computer software program. Entry into the program includes the results of the background check 19, the modified credit check 20 and the employment check 22. Where the renter does not qualify against the lease warranty criteria 14, the program outputs that no warranty is possible 46. Where the renter qualifies against the lease warranty criteria 14, the program outputs the guarantor fee agreement 38, the range of rent in which the warranty 16 is valid and a list of landlords 43 who would be willing to enter a warranted lease agreement 40.

In at least some embodiments, a commercial implementation of the methods described herein may be made available in the form of a program that is offered by a guarantor company to landlords, property managers, mortgage lenders, and the like. The individual landlord, property manager, or lender is invited to register with the guarantor via a website. Registration may involve “joining,” “becoming a member,” or the like. Once registered, the individual landlord, property manager, or lender may purchase the rental warranty program under whatever terms the guarantor wishes to offer. In at least some embodiments, the rental warranty program is offered on a tenant-by-tenant basis, wherein the landlord, property manager, or lender purchases a new policy for each individual tenant.

In at least some embodiments, the guarantor may offer the registered landlords, property managers, mortgage lenders the opportunity to purchase an additional insurance program whereby, when an eviction must be made, the guarantor pays an “evictions expense” amount, which may be, for example, $500 per claim.

In at least some embodiments, the same website that is used to register and administer to landlords and property managers is also used by the landlords, property managers, mortgage lenders to purchase individual policies for respective leases or mortgages, manage the qualification process for tenants or purchasers, make claims when a tenant or purchaser defaults, and the like.

Advantageously, individuals who are applying for a lease but who do not qualify against conventional creditworthiness criteria can be qualified under less stringent criteria with a third party where upon the third party warrants the landlord against default by the potential renter and the previously unobtainable lease agreement may be consummated.

Based on the foregoing information, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention.

Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements; the present invention being limited only by the claims appended hereto and the equivalents thereof.

What is claimed is:

1. A method of warranting receipt of payment by a landlord for a renter, thereby enabling housing for a greater number of people, comprising:
(a) generating, by a guarantor, a list of landlords seeking to enter into a warranted lease agreement, the list including at least one residential space offered by each respective landlord;
(b) utilizing, by a potential renter, a computer program stored on a computer readable media and implemented by a computer, to select a desired residential space;
(c) utilizing a computer program stored on a computer readable media implemented by a computer, qualifying the potential renter against a lease warranty criteria including:
(i) qualifying the renter against a background check,
(ii) qualifying the renter against a credit check, and
(iii) qualifying the renter against an employment check;
(d) utilizing a computer program stored on a computer readable media implemented by a computer, calculating the cost of a warranted lease of the desired residential space for the potential renter wherein the cost is graduated on the basis of the qualifying step and on other predetermined criteria;
(e) warranting receipt of payment, by the landlord of the desired residential space with a warranty, by the lease guarantor, against default by the renter, whereby the landlord offers the warranted lease to the renter; and
(f) entering into the warranted lease upon acceptance by the landlord and the renter.

2. The method of claim 1, further comprising a step of making payment, upon a default by the renter (default being defined as a failure by the renter to make his lease payment to the landlord), making payment, by the guarantor, of the lease payment to the landlord.

3. The method of claim 1, wherein an ejectment conviction is required before the renter is in default.

4. The method of claim 3, further comprising a step of the potential renter completing a guarantor's application on an internet website to qualify the renter against the lease warranty criteria.

5. The method of claim 1, further comprising a step of providing the list of landlords in the form of a database.

6. The method of claim 5, further comprising a step of notifying the landlords in the database, via the Internet, of qualification by the guarantor.

7. A method of enabling housing for a greater number of people, where a guarantor warrants against default, said method comprising:
(a) qualifying a potential renter a chance to rent a desired residential space against a lease warranty criteria including:
(i) qualifying the renter against a background check,
(ii) qualifying the renter against a credit check, and
(iii) qualifying the renter against an employment check;
(b) utilizing a computer program stored on a computer readable media implemented by a computer, calculating the cost of a warranted lease of the space for the potential renter wherein the cost is graduated on the basis of the potential renter's annual income, where the renter is qualified, regardless of: judgment for non-payment of rent, bankruptcy, automobile repossession, unpaid medical bills, unpaid student loans and lack of credit;
(c) generating a list of landlords seeking to enter into a warranted lease agreement, said potential renter utilizing the list to select the desired residential space;
(d) offering a warranted lease to the renter;
(e) selling the lease warranty to the landlord leasing the space when the renter enters into the warranted lease; and
(f) warranting the landlord against default by the renter.

8. A method of enabling housing for a greater number of people, where a guarantor warrants against default, said method comprising:
(a) qualifying a renter a chance to rent a desired residential space against a lease warranty criteria including:
(i) qualifying the renter against a background check,
(ii) qualifying the renter against a credit check, and
(iii) qualifying the renter against an employment check;
(b) utilizing a computer program stored on a computer readable media implemented by a computer, calculating the cost of a warranted lease of the space for the potential renter wherein the cost is graduated on the basis of the potential renter's annual income, where the renter is qualified, regardless of: judgment for non-payment of rent, bankruptcy, automobile repossession, unpaid medical bills, unpaid student loans and lack of credit;
(c) generating a list of landlords seeking to enter into a warranted lease, said potential renter utilizing the list to select the desired residential space;
(d) offering the lease warranty to the renter; and
(e) selling the lease warranty to the renter when the renter enters into a lease with a landlord; wherein the warranty warrants the landlord against default by the renter.
